(19) United States
(12) Patent Application Publication
(10) Pub. No.: US 2026/0202708 A1
(43) Pub. Date: Jul. 16, 2026

(54) REFLECTIVE COLOR DISPLAY WITH MICRO-PARTITIONED COLOR FILTER LAYER

(71) Applicant: SUPERC-TOUCH CORPORATION, New Taipei City (TW)

(72) Inventors: Hsiang-Yu LEE, New Taipei City (TW); Shang CHIN, New Taipei City (TW); Ping-Tsun LIN, New Taipei City (TW); Chia-Cheng LEI, New Taipei City (TW); Kun-Yu CHEN, New Taipei City (TW)

(73) Assignee: SUPERC-TOUCH CORPORATION, New Taipei City (TW)

(21) Appl. No.: 19/442,408

(22) Filed: Jan. 7, 2026

(30) Foreign Application Priority Data
Jan. 10, 2025 (TW) 114101184

(51) Int. Cl. G02F 1/1677

(52) U.S. Cl. CPC G02F 1/1677; G02F 2203/02

(57) ABSTRACT

A reflective color display with micro-partitioned color filter layer includes a first substrate, a thin film transistor layer, a pixel electrode layer, a color filter layer, and a display material layer. The pixel electrode layer includes a plurality of pixel electrodes and the color filter layer includes a plurality of color filter blocks. Part of the color filter blocks are in one-by-one correspondence with the pixel electrodes, part of the color filter blocks are in multiple-to-one or one-to-multiple correspondence with the pixel electrodes. The display material layer includes a micro partition structure with a plurality of partition walls, cavities defined by the micro partition structure, and colloidal solution filled in the cavities and containing a plurality of suspended charged color particles.

### CROSS-REFERENCE TO RELATED APPLICATION

This application claims benefit of priority to Taiwanese Patent Application No. 114101184 filed Jan. 10, 2025, the entire contents of which are incorporated herein by reference.

### BACKGROUND OF THE DISCLOSURE

### Technical Field

This invention relates to a reflective color display, and more particularly to a reflective color display with a micro-partitioned color filter layer.

### Description of Related Art

The ideal electronic paper needs to have advantages of lightweight, low energy consumption, and flexibility. In addition, electronic paper can retain images even after power off. Therefore, electronic paper has been widely used in applications such as books, labels, posters, bulletin boards, etc. In the past, various electronic paper technologies have been proposed, such as electronic powder fluid (quick response liquid powder display), cholesteric liquid crystal display and other displays. However, electrophoresis displays (EPDs) are still the mainstream in view of practical considerations such as image display quality, electronic drive system design complexity and mass production stability. In addition, with more desirable application, color electronic paper has gradually become a development focus. Color electronic paper is bistable color display and does not require power to maintain the displayed image except the situation of updating display content. In comparison with liquid crystal displays (LCDs) constantly needing power, color electronic paper significantly reduces power consumption. The other advantages of the color electronic paper include environmentally friendly, energy-saving, eye-friendly, and viewable in sunlight. The electronic paper and reflective LCDs display images by reflecting ambient light, which are different with conventional backlit LCDs which emit blue light. Therefore, the user feels more comfortable for the eyes thereof and less tiring when viewing electronic paper displays or reflective LCDs.

The existing color electronic paper can mimic the LCD display manner, namely, use color photoresists (such as three primary color RGB photoresists) on the color filters to filter out part of the spectrum in white light to convert the white light into colored light. This technology only requires two-color electronic ink films (black and white) in conjunction with color filter blocks. However, this technology suffers the biggest weakness below. Two-thirds of the incident white light is absorbed by the color filter blocks, and only about one-third of the incident light can be reflected, resulting in darker image. The traditional LCDs solve this problem by using high-brightness backlights to compensate the reduced brightness caused by the color filter mechanism to maintain the image at normal brightness. However, this also causes excessive power consumption. The color electronic paper not equipped with backlighting cannot overcome this issue, and the relevant industry has spent over a decade to developpe solution in vain. Currently, the color electronic paper using color filter mechanism relies on front light to supplement brightness. However, due to structural limitations and reflection principles, the effectiveness of the front light is far inferior to that of LCD backlighting. Furthermore, the addition of a front light significantly influences the eye-friendly features of the color electronic paper.

As shown in FIG. 8, the prior art color electrophoresis display 100 includes, from top to bottom, an upper glass substrate 16, a color filter layer CF, an optical adhesive 13, an opposite substrate 12 (for example, a transparent plastic substrate), a common electrode layer 14 (for example, a transparent conductive electrode layer), a display material layer 20 (for example, an electrophoresis layer), a pixel electrode layer PEL, a thin-film transistor layer 30, and a control substrate 10 (for example, a glass substrate). As shown in FIG. 8, the display material layer 20 includes a plurality of hollow micro-cups 22 (only one is shown in the figure), and a colloidal solution 24 filled in each of the micro-cups 22. The colloidal solution 24 contains a plurality of suspended charged color particles 26 (for example, charged black particles 26B and charged white particles 26W). The hollow micro-cups 22 serves as containers for electronic ink (or electrophoresis material). The hollow micro-cups 22 are, for example, made of organic polymer materials and are used to fill the charged color particles 26.

The common electrode layer 14 is generally connected to ground level (OV) to provide a common voltage Vcom, and the underlying control substrate 10 generally uses the TFT array process of a panel to fabricate a driving circuit layer and a thin-film transistor layer 30. The charged color particles 26 carry charges of predetermined polarities. For example, the charged black particles 26B are positively charged and the charged white particles 26W are negatively charged. By controlling the electrical properties and voltage for each of the pixel electrodes PE through driving the thin-film transistor layer 30 by the driving circuit layer (not shown), the charged black particles 26B are attracted and the charged white particles 26W are repelled for each pixel (such that the pixel appears white on the viewing surface opposite to the pixel electrode PE) or the charged white particles 26W are attracted to location near the color filter block and the charged black particles 26B are repelled for each pixel, thereby displaying a predetermined image on the display surface, such as the surface close to the upper glass substrate 16.

The electrophoresis displays with color filter arrays rely on area sharing and color mixing to produce viewable colors. Available display areas are shared among the three primary colors, such as red/green/blue (RGB) or red/green/blue/white (RGBW), or the three primary colors plus white. The color filter layers can be arranged in a one-dimensional (stripes) or two-dimensional (2×2) repeating patterns. If the three pixels (in the RGB display case) or the four pixels (in the RGBW display case) are small enough, those pixels can be seen as a single pixel unit (display unit) with uniform color with high resolution and visually blending color.

FIG. 1A shows an embodiment of a prior art color filter layer CF. With reference to this figure, this color filter layer CF is, for example, a red/green/blue (RGB) color filter layer for three primary colors. Each of the color filter layers includes color filter blocks in substantially rectangular shape for three primary colors, and the color filter block for one primary color (for example, red filter block R) is surrounded by color filter blocks of other colors (for example, blue filter block B or green filter block G). FIG. 1B shows the color mixing methods for displaying red, green, and blue colors respectively according to the color filter layer CF in FIG. 1A. With reference also to FIG. 8, if a display unit is planned to display red color, the pixel electrode PE1 corresponding to the red filter block R is applied with a driving voltage under the control of the thin-film transistor layer 30 to attract charged white particles 26W to location near the color filter block to reflect light. Therefore, the area corresponding to the red filter block R display red color. Similarly, the pixel electrodes PE2 and PE3 corresponding to the green filter block G and the blue filter block B can be applied with a driving voltage under the control of the thin-film transistor layer 30 to attract charged black particles 26B to location near the color filter block to not reflect light. Therefore, the areas corresponding to the green filter block G and the blue filter block B are black (K) color, thereby making the pixel display red color. Under this condition, the color and brightness of this display unit (containing three pixels) are R+Black+Black=R.

Similarly, if a display unit is planned to display green color, the pixel electrode PE2 corresponding to the green filter block G is applied with a driving voltage through the thin-film transistor layer 30 controlled by the driving circuit layer to attract charged white particles 26W to location near the color filter block to reflect light. Therefore, the area corresponding to the green filter block G displays green color. Similarly, the pixel electrodes PEL and PE3 corresponding to the red filter block R and the blue filter block B can be applied with a driving voltage through the thin-film transistor layer 30 to attract charged black particles 26B to location near the color filter block to not reflect light. Therefore, the areas corresponding to the red filter block R and the blue filter block B are black (K), thereby making the pixel display green color. Under this condition, the color and brightness of this display unit (containing three pixels) are G+Black+Black=G.

If a display unit is planned to display blue color, the corresponding pixel electrodes PE1 to PE3 can be controlled in a similar manner. In this case, the color and brightness of this display unit (containing three pixels) are B+Black+Black=B. However, in this control method, only ⅓ of each pixel display color, while 2/3 are black, so the overall brightness is relatively dim.

With reference to FIG. 1C, this figure is a schematic diagram to show the color mixing methods for displaying yellow (Y), magenta (M), and cyan (C) based on the color filter layer CF in FIG. 1A. If a display unit is planned to display yellow color, the pixel electrode PE1 corresponding to the red filter block R and the pixel electrode PE2 corresponding to the green filter block G are applied with driving voltages under the control of the thin-film transistor layer 30 to attract charged white particles 26W to location near the color filter block to reflect light. The pixel electrode PE3 corresponding to the blue filter block B is applied with a driving voltage under the control of the thin-film transistor layer 30 to attract charged black particles 26B to location near the color filter block to not reflect light, making the area corresponding to the blue filter block B is black (K). The areas corresponding to the red filter block R and the green filter block G can display red color and green color respectively, and the color additive effect is yellow. In this case, the color and brightness of this display unit (containing three pixels) are R+G+Black=Y.

Similarly, if a display unit is planned to display magenta color, the pixel electrode PE1 corresponding to the red filter block R and the pixel electrode PE3 corresponding to the blue filter block B are applied with driving voltages under the control of the thin film transistor layer 30 to attract charged white particles 26W to location near the color filter block to reflect light. The pixel electrode PE2 corresponding to the green filter block G is applied with a driving voltage under the control of the thin film transistor layer 30 to attract charged black particles 26B to location near the color filter block to not reflect light. The area corresponding to the green filter block G is black (K), while the areas corresponding to the red filter block R and the blue filter block B display red color and blue color respectively, and the colors are additive to form magenta color. In this case, the color and brightness of this display unit (containing three pixels) are B+R+Black=M.

If a display unit is planned to display cyan color, the corresponding pixel electrodes PE1 to PE3 can be controlled in a similar manner. In this situation, the color and brightness of this display unit (containing three pixels) are B+G+Black=C. However, according to the above control method, only ⅔ of these pixels have color, while 1/3 portion of these pixels is black; this will result in brightness differences between displaying red, blue, and green, and displaying yellow, magenta, and cyan.

With reference to FIG. 1D, this figure is a schematic diagram to show the color mixing methods for displaying white (W) and black (K) based on the color filter layer CF in FIG. 1A. If a display unit is planned to display white, the pixel electrode PE1 corresponding to the red filter block R, the pixel electrode PE2 corresponding to the green filter block G, and the pixel electrode PE3 corresponding to the blue filter block B are applied with driving voltages under the control of the thin-film transistor layer 30 to attract charged white particles 26W to location near the color filter block to reflect light, so that the color of this pixel is the additive of the three primary colors of red, green, and blue to form white color. In this case, the color and brightness of this display unit (containing three pixels) are R+G+B=W.

If a display unit is planned to display black, the pixel electrode PE1 corresponding to the red filter block R, the pixel electrode PE2 corresponding to the green filter block G, and the pixel electrode PE3 corresponding to the blue filter block B are applied with driving voltages through the thin film transistor layer 30 to attract charged black particles 26B to location near the color filter block to not reflect light, so that the areas corresponding to these three color filter blocks RGB are all displayed as black (K) color.

FIGS. 2A and 2B shows another prior art color filter layer CF. As shown in FIG. 2A, this color filter layer CF is, for example, a red/green/blue (RGB) color filter layer for three primary colors, and each color filter layer containing color filter blocks in substantially rectangular shape for the three primary colors. Besides, as shown in FIG. 2B, the area of the color filter blocks only occupies 1/2 of the original area, while the remaining 1/2 area is a light-transmitting area without any color filtering effect.

With reference to FIG. 2C, this figure is a schematic diagram to show the color mixing methods for displaying red, green, and blue colors (three primary colors) based on the color filter layer CF in FIGS. 2A and 2B. With reference also to FIG. 9, if a display unit is planned to display red color, the pixel electrode PE1 corresponding to the red filter color block R is applied with a driving voltage through the control of the thin film transistor layer 30 to attract charged white particles 26W to location near the color filter block to reflect light, so that the area corresponding to the red filter color block R displays red color (1/2 area displays red light and the remaining 1/2 area is white light). Besides, the pixel electrodes PE2 and PE3 corresponding to the green filter block G and the blue filter block B are applied with driving voltages under the control of the thin-film transistor layer 30 to attract charged black particles 26B to location near the color filter block to not reflect light, rendering the areas corresponding to the green filter block G and the blue filter block B display black (K), thereby making the display unit display red color. In this case, the color and brightness of this display unit (containing three pixels) are 0.5R+0.5W+Black+Black=0.5R+0.5W.

Similarly, if a display unit is planned to display green, the pixel electrode PE2 corresponding to the green filter block G is applied with a driving voltage under the control of the thin-film transistor layer 30 to attract charged white particles 26W to location near the color filter block to reflect light, so that the area corresponding to the green filter block G display green color (1/2 area displays green and the remaining 1/2 area is white). Besides, the pixel electrodes PEL and PE3 corresponding to the red filter block R and the blue filter block B are applied with driving voltages under the control of the thin-film transistor layer 30 to attract charged black particles 26B to location near the color filter block to not reflect light, so that the areas corresponding to the red filter block R and the blue filter block B are black (K) color, thereby making the display unit display green color. In this case, the color and brightness of this display unit (containing three pixels) are 0.5G+0.5W+Black+Black=0.5G+0.5W.

If a display unit is planned to display blue color, the corresponding pixel electrodes PE1 to PE3 can be controlled in a similar manner. In this case, the color and brightness of this display unit containing three pixels are 0.5B+0.5W+Black+Black=0.5B+0.5W. In comparison with the first prior art method, the color filter layer CF shown in FIGS. 2A and 2B can improve brightness, however, the color saturation thereof is sacrificed, resulting in a whitening effect to display color close to Morandi colors.

With reference to FIG. 2D, this figure is a schematic diagram to show the color mixing methods for displaying yellow (Y), magenta (M), and cyan (C) based on the color filter layer CF in FIGS. 2A and 2B. If a display unit is planned to display yellow color, the pixel electrode PE1 corresponding to the red filter block R and the pixel electrode PE2 corresponding to the green filter block G are applied with driving voltages through the driving circuit layer 30 to attract charged white particles 26W to location near the color filter block to reflect light. Meanwhile, the pixel electrode PE3 corresponding to the blue filter block B is applied with a driving voltage through the thin-film transistor layer 30 to attract charged black particles 26B to location near the color filter block to not reflect light, rendering the area corresponding to the blue filter block B display black (K) color. The areas corresponding to the red filter block R and the green filter block G respectively display red color (1/2 area displays red light and the remaining 1/2 area displays white light) and green color (1/2 area displays green light and the remaining 1/2 area displays white light). The resulting color, after color additive scheme, is yellow. In this case, the color and brightness of this display unit containing three pixels are 0.5R+0.5W+0.5G+0.5W+Black=0.5Y+1W.

Similarly, if a display unit is planned to display magenta color, the pixel electrode PE1 corresponding to the red filter block R and the pixel electrode PE3 corresponding to the blue filter block B are applied with driving voltages under the control of the thin-film transistor layer 30 to attract charged white particles 26W to location near the color filter block to reflect light. Meanwhile, the pixel electrode PE2 corresponding to the green filter block G is applied with a driving voltage under the control of the thin-film transistor layer 30 to attract charged black particles 26B to location near the color filter block to not reflect light. The area corresponding to the green filter block G displays black (K) color, while the areas corresponding to the red filter block R and the blue filter block B display red (half of the area is red light and the remaining half is white light) and blue color (half of the area is blue light and the remaining half is white light) respectively. The resulting color, after color additive scheme, is magenta. In this case, the color and brightness of this display unit containing three pixels are 0.5R+0.5W+0.5B+0.5W+Black=0.5M+1W.

If a display unit is planned to display cyan color, the corresponding pixel electrodes PE1 to PE3 can be controlled in a similar manner. In this case, the color and brightness of this display unit containing three pixels are 0.5B+0.5W+0.5G+0.5W+Black=0.5C+1W. Similarly, although this color filter layer CF shown in FIGS. 2A and 2B improves brightness, the color saturation is sacrificed. Furthermore, the color saturation is even worse when displaying yellow, magenta, and/or cyan color.

With reference to FIG. 2E, this figure is a schematic diagram to show the color mixing methods for displaying white (W) and black (K) based on the color filter layer CF in FIGS. 2A and 2B. If a display unit is planned to display white color, the pixel electrode PE1 corresponding to the red filter block R, the pixel electrode PE2 corresponding to the green filter block G, and the pixel electrode PE3 corresponding to the blue filter block B are applied with driving voltages under the control of the thin-film transistor layer 30 to attract charged white particles 26W to location near the color filter block to reflect light, so that the color of these pixels is the addition of the three primary colors of red, green, and blue to become white color. In this case, the color and brightness of this display unit containing three pixels are 0.5R+0.5W+0.5G+0.5W+0.5B+0.5W=(0.5R+0.5G+0.5B)+1.5W=2W.

If a display unit is planned to display black color, the pixel electrode PE1 corresponding to the red filter block R, the pixel electrode PE2 corresponding to the green filter block G, and the pixel electrode PE3 corresponding to the blue filter block B are applied with driving voltages through the thin film transistor layer 30 to attract charged black particles 26B to location near the color filter block to not reflect light, so that the area corresponding to these three color filter blocks RGB displays black (K) color.

However, there is still room for improvement in the conventional color filter layer (CF). Besides, the prior art techniques for filling micro-cups with colloidal solutions (containing charged colored particles) have drawbacks such as affecting yield and aperture ratio.

### SUMMARY OF THE INVENTION

The invention is to provide a reflective color display with a micro-partitioned color filter layer. By the specially designed color filter layer, this reflective color display can have better brightness and color saturation, and can improve the shortcomings of conventional micro-cup technology.

Accordingly, the present invention provides a reflective color display with micro-partitioned color filter layer, the reflective color display comprising:
a first substrate comprising a first surface and a second surface, wherein a thin-film transistor layer and a pixel electrode layer are formed on the second surface, the thin-film transistor layer comprises a plurality of thin-film transistors, a plurality of gate lines and a plurality of data lines and a plurality of storage capacitors, the plurality of gate lines are arranged along a first direction, the plurality of data lines are arranged along a second direction, the first direction and the second direction are substantially perpendicular to each other, and the pixel electrode layer comprises a plurality of pixel electrodes;
a color filter layer comprising a plurality of color filter blocks, wherein for at least half of the color filter blocks, any two adjacent color filter blocks do not overlap in the projection direction, or an overlapping area of the adjacent color filter blocks in the projection direction is less than 30% of an area of a single one of the filter color blocks; wherein part of the color filter blocks have one-to-one correspondence with the plurality of pixel electrodes, part of the color filter blocks have multiple-to-one or one-to-multiple correspondence with the plurality of pixel electrodes; and
a display material layer arranged in a direction away from the second surface of the first substrate, wherein the display material layer comprises micro-partition structures having multiple partition walls, and a colloidal solution containing multiple suspended charged color particles filled in cavities defined by each of the micro-partition structures.

### BRIEF DESCRIPTION OF THE DRAWINGS

FIG. 1A shows an embodiment of a prior art color filter layer CF.

FIG. 1B shows the color mixing methods for displaying red, green, and blue colors respectively according to the color filter layer in FIG. 1A.

FIG. 1C is a schematic diagram to show the color mixing methods for displaying yellow (Y), magenta (M), and cyan (C) based on the color filter layer in FIG. 1A.

FIG. 1D is a schematic diagram to show the color mixing methods for displaying white (W) and black (K) based on the color filter layer in FIG. 1A.

FIGS. 2A and 2B shows another prior art color filter layer.

FIG. 2C shows the color mixing methods for displaying red, green, and blue colors respectively according to the color filter layer in FIGS. 2A and 2B.

FIG. 2D is a schematic diagram to show the color mixing methods for displaying yellow (Y), magenta (M), and cyan (C) based on the color filter layer in FIGS. 2A and 2B.

FIG. 2E is a schematic diagram to show the color mixing methods for displaying white (W) and black (K) based on the color filter layer in FIGS. 2A and 2B.

FIG. 3A is a schematic diagram showing the color filter layer applicable to the reflective color display with micro-partitioned color filter layer according to the present invention.

FIG. 3B is a schematic diagram showing the color filter layer applicable to the reflective color display with micro-partitioned color filter layer according to another embodiment of the present invention.

FIG. 4A shows the color mixing methods for displaying red, green, and blue colors respectively according to the color filter layer in FIG. 3A.

FIG. 4B is a schematic diagram to show the color mixing methods for displaying yellow (Y), magenta (M), and cyan (C) based on the color filter layer in FIG. 3A.

FIG. 4C is a schematic diagram to show the color mixing methods for displaying white (W) and black (K) based on the color filter layer in FIG. 3A.

FIG. 5A is a schematic diagram showing a reflective color display with micro-partitioned color filter layer according to the present invention.

FIG. 5B is a schematic diagram showing a reflective color display with micro-partitioned color filter layer according to another embodiment of the present invention.

FIG. 5C is a schematic diagram showing a reflective color display with micro-partitioned color filter layer according to another embodiment of the present invention.

FIG. 5D is a schematic diagram showing a reflective color display with micro-partitioned color filter layer according to another embodiment of the present invention.

FIG. 6A is a schematic diagram showing a reflective color display with micro-partitioned color filter layer according to another embodiment of the present invention.

FIG. 6B is a schematic diagram showing a reflective color display with micro-partitioned color filter layer according to another embodiment of the present invention.

FIGS. 7A and B are sectional view and top view for explaining the structure and manufacturing process of the thin film transistor layer and related components on the control substrate of the present invention.

FIG. 8 shows a schematic view of the prior art color electrophoresis display.

FIG. 9A shows is a top-view of the micro-cup compartment of the prior art electrophoresis display and the color filter layer thereof.

FIG. 9B is a top-view of the micro-partition structure in accordance with an embodiment of the present invention.

FIG. 9C is another top-view of the micro-partition structure in accordance with an embodiment of the present invention.

FIG. 9D is a top-view of the micro-partition structure in accordance with another embodiment of the present invention.

FIGS. 10A to 10D are sectional views showing the flowcharts for fabrication of the micro-partition structure according to an embodiment of the present invention.

FIGS. 11A to 11F are sectional views showing the flowcharts for fabrication of the partition wall of the micro-partition structure according to an embodiment of the present invention.

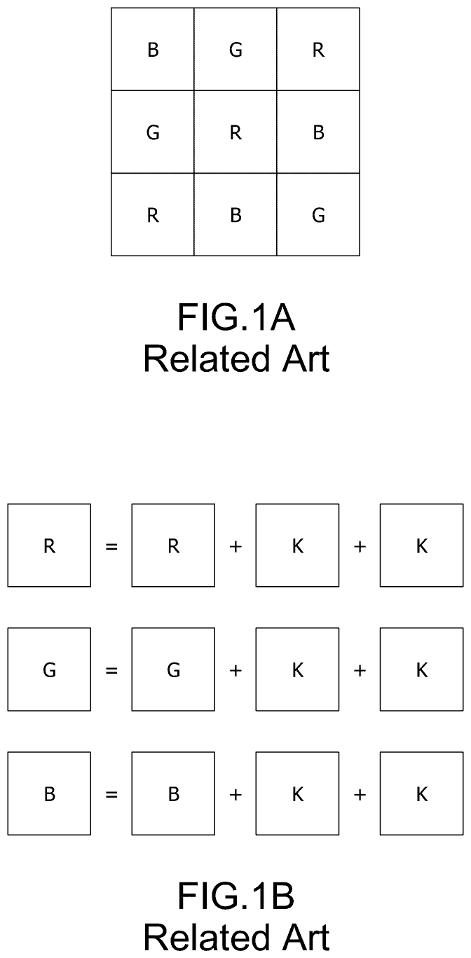

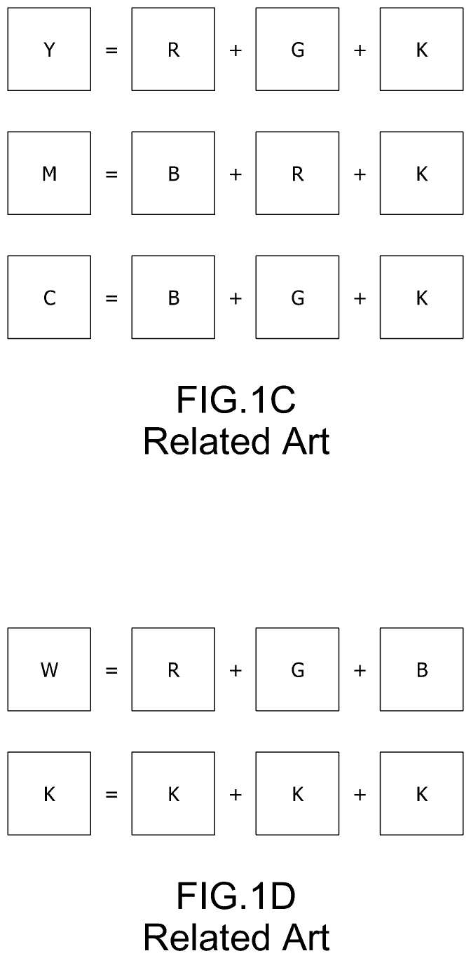

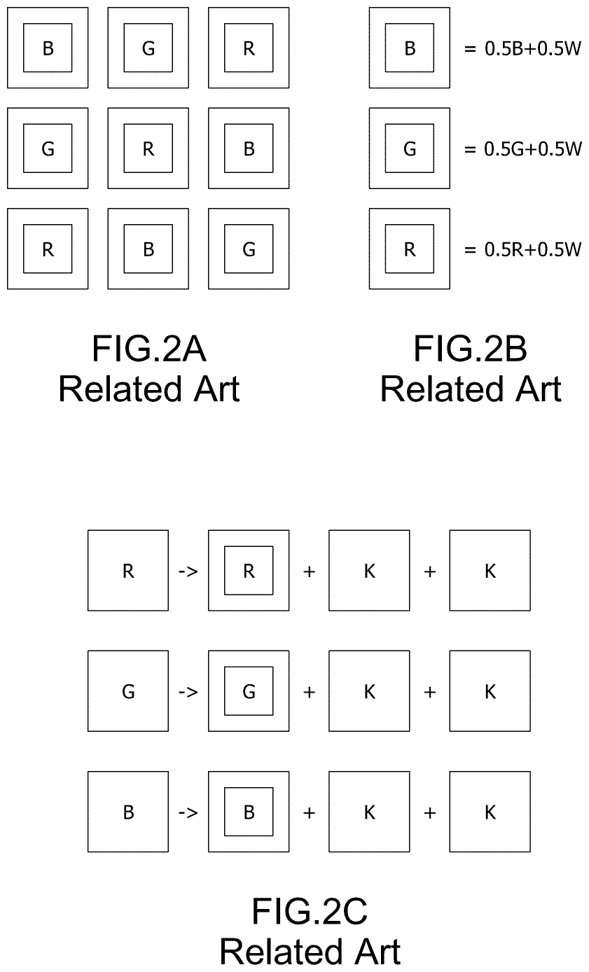

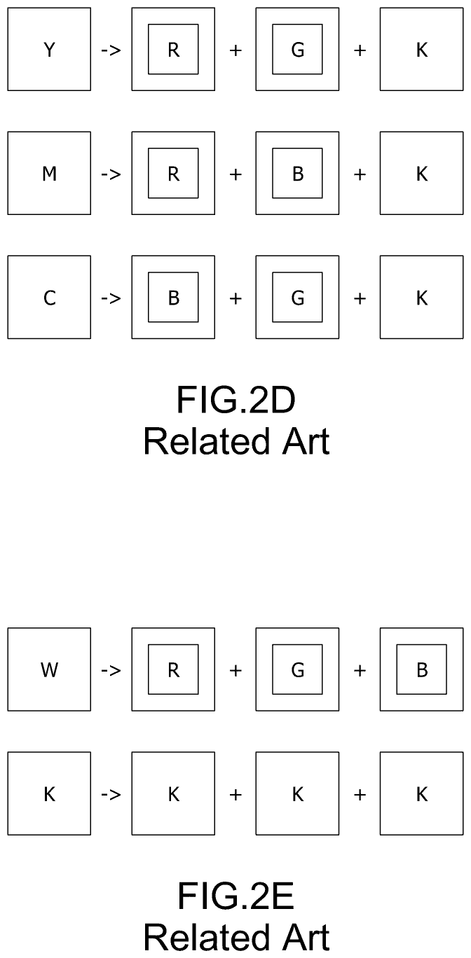

### DETAILED DESCRIPTION

It should be understood that the orientations or positional relationships in this disclosure which are indicated by the terms such as “front side”, “rear side”, “left side”, “right side”, “front end”, “rear end”, “end”, “vertical”, “horizontal”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

In the description below, terms such as “first,” “second,” “third,” “fourth,” and “fifth” describe various elements, components, regions, layers, and/or parts, which should not be limited by these terms. These terms are used only to distinguish one element, component, region, layers, or part from another. Unless the context clearly indicates otherwise, the use of terms such as “first,” “second,” “third,” “fourth,” and “fifth” herein does not imply order or sequence.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

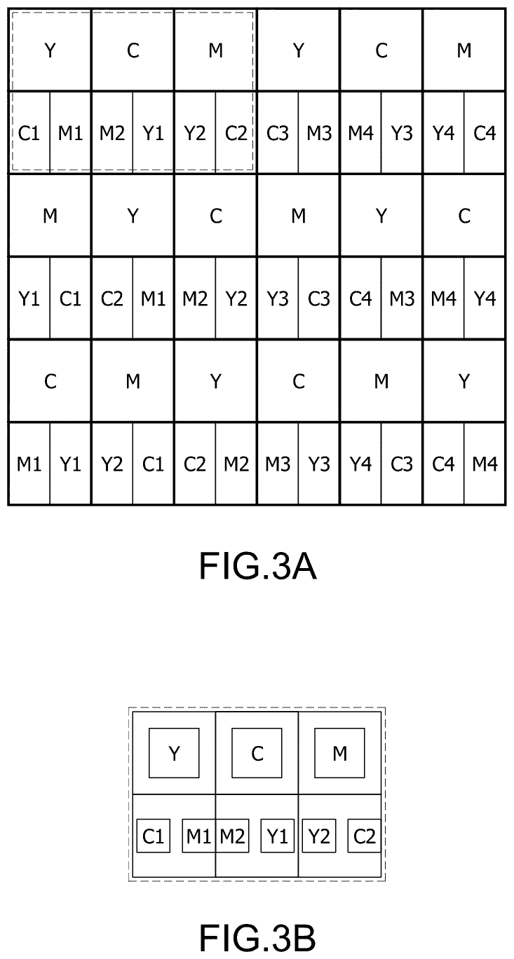

With reference to FIG. 3A, this figure is a schematic diagram showing the color filter layer CF applicable to the reflective color display 100 with micro-partitioned color filter layer according to the present invention. This color filter layer CF includes multiple color filter blocks Y, Y1~Y4, C, C1~C4, M, M1~M4. According to one embodiment of the present invention, the color filter blocks are arranged on the same plane, and there is no overlap between adjacent color filter blocks in the projection direction. However, those skilled in the art will understand that due to process factors during the fabrication of the color filter blocks, some adjacent color filter blocks may have overlap therebetween. According to one embodiment of the present invention, the overlapping area of the adjacent color filter blocks in the projection direction is less than 30% of the area of a single color filter block; according to another embodiment of the present invention, the overlapping area of adjacent color filter blocks in the projection direction is less than 20% of the area of a single color filter block. According to still another embodiment of the present invention, for at least half of the color filter blocks, any two adjacent color filter blocks do not have overlap therebetween in the projection direction. Besides, according to the present invention, the color filter blocks are also arranged on different planes or on the same plane, as long as the overlapping area of the adjacent color filter blocks, even if they are not on the same plane, in the projection direction is less than 30% or 20% of the area of a single filter color block, or for at least half of the filter color blocks, any two adjacent color filter blocks do not have overlap therebetween in the projection direction. The above different embodiments are within the scope of the present invention.

Furthermore, as shown in Fig. FIG. 3A, at least six color filter blocks are combined to form a full-color filter pixel unit (as shown in the dashed box). For example, the seven color filter blocks Y, C, M and C1, (M1, M2), (Y1, Y2), C2 are combined to form a full-color filter pixel unit, so that these full-color filter pixel units extend in both the horizontal and vertical directions to form a complete color filter layer CF. When these full-color filter pixel units extend in the horizontal or vertical direction, there is an offset displacement between adjacent rows or columns in the vertical or horizontal direction. As shown in FIG. 3A, the color filter block C at the upper left corner and the color filter block C2 in the second row are arranged with an offset of one and a half pixel electrodes, where one pixel electrode is corresponding to the position of the thick frame in FIG. 3A. That is, the color filter blocks in the second row are formed by offsetting the first row of color filter blocks by one and a half pixel electrodes; the color filter blocks in the third row are formed by offsetting the second row of color filter blocks by half a pixel electrode. However, according to the present invention, the color filter blocks can be arranged or formed in different ways as needed. For example, if the positions of the color filter blocks Y2 and C2 are swapped, that is, if the filter color blocks C2+C3 are not connected, then the filter color blocks in the second row are offset from the filter color blocks in the first row by one pixel electrode. In the following description, the color filter layer CF of FIG. 3A is used for demonstration, and at least six filter color blocks are combined to form a full-color filter pixel unit (as shown in the dashed box) for illustration.

FIG. 3B is a schematic diagram showing a color filter layer applicable to the reflective color display with micro-partitioned color filter layer according to another embodiment of the present invention. According to another embodiment of the present invention, each of the filter color blocks needs not have the same area as that of the corresponding pixel electrode PE. At least part of the filter color blocks may have a corresponding partial area. For example, the filter color block may have an area of 70% of the area of the corresponding pixel electrode PE, with the remaining 30% being the light-transmitting area. It should be noted that, for the sake of simplicity, FIG. 3B only illustrates the color filter block structure of the “full-color pixel filter unit” corresponding to the upper left side of FIG. 3A. However, those skilled in the art should be able to modify the other filter block structures in FIG. 3A based on the layout shown in FIG. 3B. As shown in FIG. 3B, when fabricating the color filter layer of the present invention, the same color filter block can span the regions corresponding to different pixel electrodes PE. For example, as shown in FIG. 3B, the color filter block (M1, M2) spans the regions corresponding to different pixel electrode. Furthermore, the adjacent color filter block(s) of the same color can also be separate color filter blocks. For example, the adjacent color filter blocks Y1 and Y2 shown in FIG. 3B are separate to each other. Furthermore, similar to the arrangement of the color filter layer in FIG. 3A, the color filter layer in FIG. 3B can have color filter blocks distributed on different planes. In the direction viewed along the projection direction, the adjacent color filter blocks, even not arranged on the same plane, have overlapping area therebetween with area less than 30% or 20% of the area of a single filter color block; alternatively, for at least half of the filter color blocks in FIG. 3B, any two adjacent color filter blocks do not have overlap therebetween in the projection direction. The above different embodiments are within the scope of the present invention.

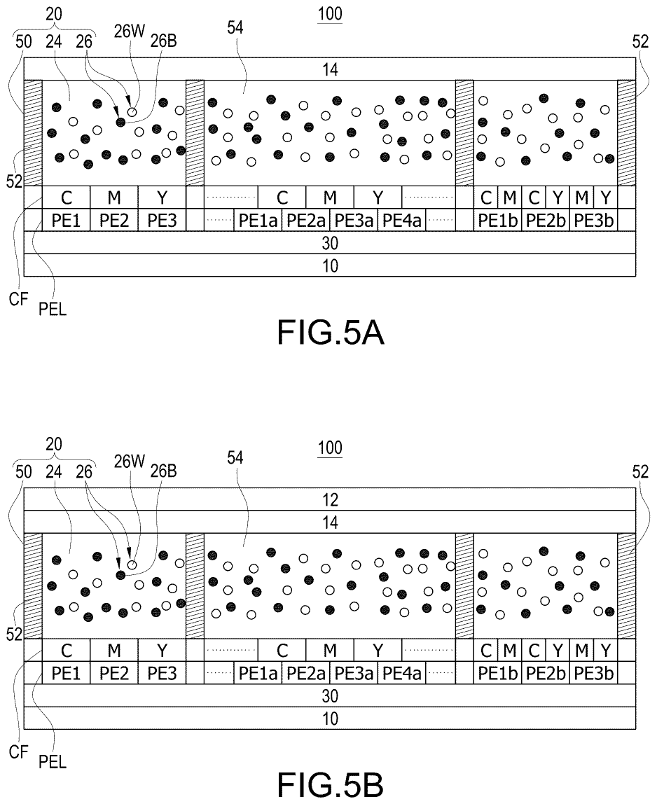

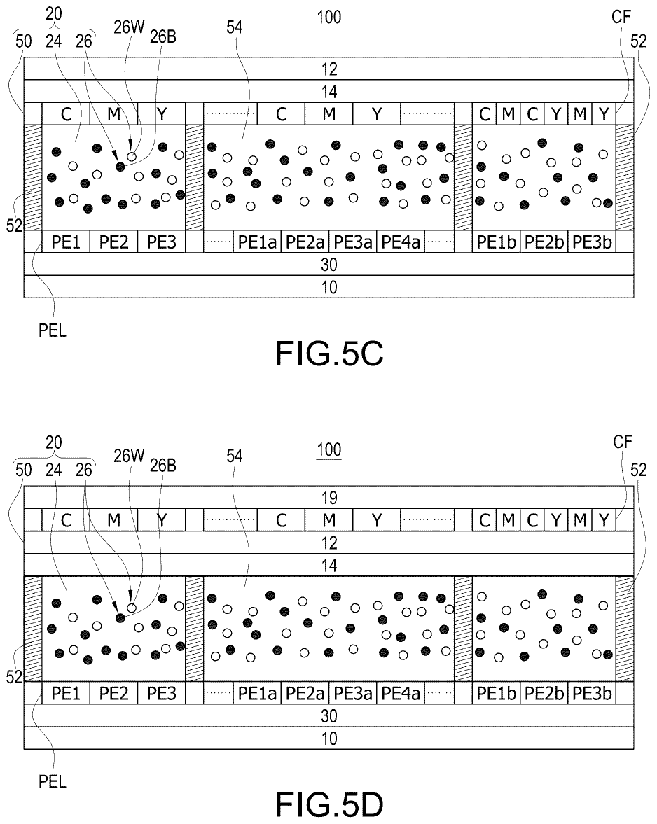

With reference to FIG. 5A, this figure is a schematic diagram showing a reflective color display 100 with micro-partitioned color filter layer according to the present invention. This reflective color display 100 is, for example, an electrophoresis color display, and includes, from top to bottom, a common electrode layer 14, a display material layer 20 (for example, an electrophoresis layer), a color filter layer CF, a pixel electrode layer PEL, a thin-film transistor layer 30, and a first substrate 10. The display material layer 20 (for example, an electrophoresis layer) includes micro-partition structures 50 with multiple partition walls 52, and a colloidal solution 24 containing multiple suspended charged color particles 26 (for example, charged black particles 26B and charged white particles 26W) in chambers 54 defined by each micro-partition structure 50. The chambers 54 defined by the micro-partition structure 50 are served as containers for electronic ink (or electrophoresis material). The detail of the micro-partition structure 50 will be described later. The color filter layer CF includes a plurality of filter color blocks C, M, Y. The pixel electrode layer PEL includes a plurality of pixel electrodes PE1, PE2, PE3 . . . . PE1a, PE2a, PE3a, PE4a . . . . PE1b, PE2b, PE3b. The electrophoresis color display of FIG. 5A does not require a substrate 12 as that shown in FIG. 5B, and the common electrode layer 14 can be bonded to the glue frame (not shown) of the display material layer 20 for fixation.

As shown in FIGS. 3A and 5A, according to the present invention, some color filter blocks (for example, the color filter blocks C, M, Y) have one-to-one correspondence with the pixel electrodes (for example, the pixel electrodes PE1, PE2, PE3); some of the color filter blocks (for example, the color filter blocks C1, M1) have multiple-to-one correspondence with the pixel electrodes (for example, the pixel electrode PE1b); and some of the color filter blocks (for example, the color filter block C) have one-to-multiple correspondence with the pixel electrodes (for example, the pixel electrodes PE1a and PE2a).

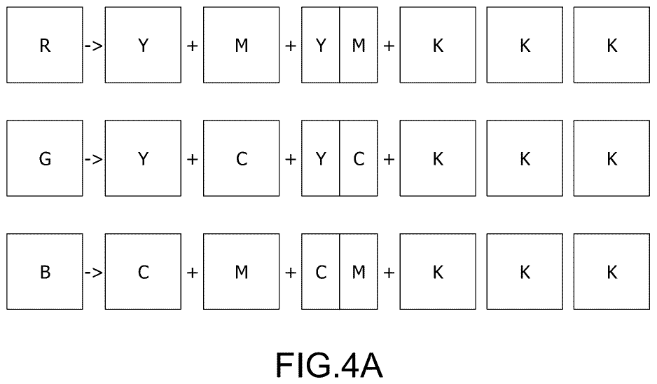

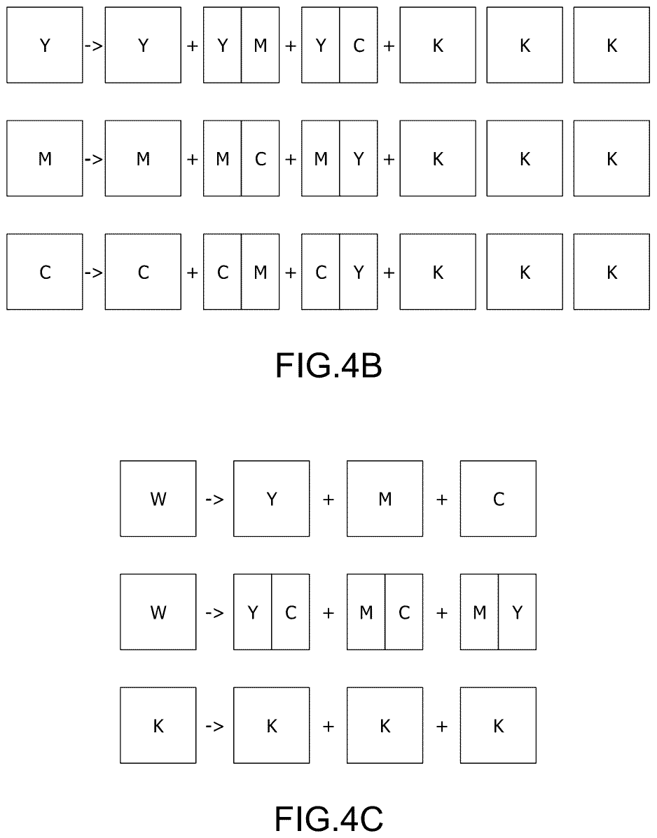

With reference to FIG. 4A, this figure shows the color mixing method for displaying red, green, and blue colors respectively based on the color filter layer CF in FIG. 3A. According to the present invention, at least six color filter blocks are combined to form a full-color filter pixel unit. If the full-color filter pixel unit is planned to display red color, the pixel electrodes corresponding to the yellow filter block Y and the magenta filter block M in FIG. 3A are applied with driving voltage to attract white particles to location near the color filter block to reflect light, while the pixel electrodes corresponding to the filter block (M2, Y1) in FIG. 3A are applied with driving voltages to attract white particles to location near the color filter block to reflect light, and the pixel electrodes corresponding to the remaining color filter blocks are applied with driving voltages to attract black particles to location near the color filter block to not reflect light, thereby mixing the yellow color and the magenta color in additive color effect to provide red color. In this case, the total brightness is Y+M+0.5Y+0.5M==1.5R+ (1.5G+1.5R+1.5B)=1.5R+1.5W.

If the full-color pixel filter unit is scheduled to display green color, the pixel electrodes corresponding to the yellow filter block Y and the cyan filter block C in FIG. 3A are applied with driving voltages to attract white particles to location near the color filter block to reflect light, while the pixel electrodes corresponding to the color filter block (Y2, C2) in FIG. 3A is applied with driving voltage to attract white particles to location near the color filter block to reflect light, and the pixel electrodes corresponding to the remaining color filter blocks are applied with suitable driving voltages to attract black particles to location near the color filter block to not reflect light. Therefore, green color is displayed by the additive color mixing of yellow color and cyan color. In this case, the total brightness is Y+C+0.5Y+0.5C=1.5Y+1.5C=1.5G+ (1.5R+1.5G+1.5B)=1.5G+1.5W.

If the full-color pixel filter unit is scheduled to display blue color, the pixel electrodes corresponding to the magenta filter block M and the cyan filter block C in FIG. 3A are applied with driving voltages to attract white particles to location near the color filter block to reflect light, while the pixel electrodes corresponding to the color filter block (C1, M1) in FIG. 3A is applied with driving voltage to attract white particles to location near the color filter block to reflect light, and the pixel electrodes corresponding to the remaining color filter blocks are applied with suitable driving voltages to attract black particles to location near the color filter block to not reflect light. Therefore, blue color is displayed by the additive color mixing of magenta color and cyan color. In this case, the total brightness is C+M+0.5C+0.5M=1.5C+1.5M=1.5B+(1.5G+1.5R+1.5B)=1.5B+1.5W.

With reference to FIG. 4B, this figure shows the color mixing method for displaying yellow (Y), magenta (M), and cyan (C) respectively based on the color filter layer CF in FIG. 3A. If this full-color filter pixel unit is scheduled to display yellow color, the pixel electrode corresponding to the yellow filter block Y in FIG. 3A is applied with suitable driving voltage to attract white particles to location near the color filter block to reflect light, the pixel electrode corresponding to the filter (M2, Y1) in FIG. 3A is applied with suitable driving voltage to attract white particles to location near the color filter block to reflect light, the pixel electrode corresponding to the color filter block (Y2, C2) in FIG. 3A is applied with suitable driving voltage to attract white particles, and the pixel electrode corresponding to the remaining color filter blocks are applied with suitable driving voltages to attract black particles to location near the color filter block to not reflect light. Therefore, yellow color is displayed by the additive color mixing of magenta color and cyan color. In this case, the total brightness is Y+0.5Y+0.5M+0.5Y+0.5C=1.5Y+ (0.5Y+0.5M+0.5C)=1.5Y+W.

If this full-color filter pixel unit is scheduled to display a magenta color, then the pixel electrode corresponding to the magenta filter block M in FIG. 3A is applied with suitable driving voltage to attract white particles to location near the color filter block to reflect light, the pixel electrode corresponding to the color filter block (C1, M1) in FIG. 3A is applied with suitable driving voltage to attract white particles to location near the color filter block to reflect light, the pixel electrode corresponding to the color filter block (Y1, M1) in FIG. 3A is applied with suitable driving voltage to attract white particles to location near the color filter block to reflect light, and the pixel electrode corresponding to the remaining color filter blocks are applied with suitable driving voltages to attract black particles to location near the color filter block to not reflect light. Therefore, magenta color is displayed by the additive color mixing of yellow color and cyan color. In this case, the total brightness is M+0.5M+0.5C+0.5M+0.5Y=1.5M+(0.5M+0.5C+0.5Y)=1.5M+W.

If this full-color filter pixel unit is scheduled to display cyan color, then the pixel electrode corresponding to the cyan filter block C in FIG. 3A is applied with suitable driving voltage to attract white particles to location near the color filter block to reflect light, the pixel electrode corresponding to the color filter block (C1, M1) in FIG. 3A is applied with suitable driving voltage to attract white particles to location near the color filter block to reflect light, the pixel electrode corresponding to the color filter block (Y2, C2) in FIG. 3A is applied with suitable driving voltage to attract white particles to location near the color filter block to reflect light, and the pixel electrode corresponding to the remaining color filter blocks are applied with suitable driving voltages to attract black particles to location near the color filter block to not reflect light. Therefore, cyan color is displayed by the additive color mixing of yellow color and magenta color. In this case, the total brightness is C+0.5C+0.5M+0.5C+0.5Y=1.5C+ (0.5M+0.5C+0.5Y)=1.5C+W.

With reference to FIG. 4C, this figure shows the color mixing method for displaying white (W) and black (B) respectively based on the color filter layer CF in FIG. 3A. If this full-color filter pixel unit is scheduled to display white color, then the pixel electrodes corresponding to all the color filter blocks in this full-color filter pixel unit, namely yellow filter block Y, cyan filter block C, magenta filter block M, color filter block (C1, M1), color filter block (M2, Y1), and color filter block (Y2, C2) are applied with suitable driving voltages through the control of the thin-film transistor layer 30 to attract charged white particles 26W to location near the color filter block to reflect light. The color of this pixel is made by adding yellow, cyan, and magenta to create white color. In this case, part of the brightness is Y+M+C=R+G+R+B+G+B=2R+2G+2B=2W, and the other part of the brightness is 0.5Y+0.5C+0.5M+0.5C+0.5M+0.5Y=2R+2G+2B=2W, for a total brightness of 4W.

If this full-color filter pixel unit is scheduled to display black color, then the pixel electrodes corresponding to all the color filter blocks in this full-color filter pixel unit, namely yellow filter block Y, cyan filter block C, magenta filter block M, color filter block (C1, M1), color filter block (M2, Y1), and color filter block (Y2, C2) are applied with suitable driving voltages through the control of the thin-film transistor layer 30 to attract charged black particles 26B to location near the color filter block to not reflect light, so that the area corresponding to all of the color filter blocks display black (K) color.

Below is a comparison table of the color filter layer CF of the present invention and the prior art color filter layer. Furthermore, because the present invention drives six pixel electrodes for a single full-color filter pixel unit, while the prior art drives three pixel electrodes, the results obtained by the present invention are obtained by multiplying the results of FIG. 4A-4C above by 50% and compare them with the prior art. As can be seen from the table below, the color filter layer CF of the present invention can balance brightness and color saturation. In addition, when a color display using the color filter layer CF of FIG. 3A displays white in full screen, its display brightness is not less than 50% of the brightness of a full white screen. The aforementioned brightness of a full-white screen is defined as the white light intensity of reflected light in the area without a color filter layer. In other word, the white light intensity of the reflected light for an area related to a single pixel electrode not blocked by the color filter layer is W. Therefore, the white light intensity of the reflected light for three pixels not blocked by the color filter layer is 3W. According to the table below, the brightness of the color display according to this invention when displaying white in full screen is 2W (after multiplying by 50%), therefore its display brightness is not less than fifty percent of the brightness of a full-white screen.

| | The present invention | Prior Art 1 | Prior Art 2 |
|---|---|---|---|
| Red | 0.75R + 0.75W | R | 0.5R + 0.5W |
| Blue | 0.75B + 0.75W | B | 0.5B + 0.5W |
| Green | 0.75G + 0.75W | G | 0.5G + 0.5W |
| Cyan | 0.75C + 0.5W | B + G | 0.5C + W |
| Magenta | 0.75M + 0.5W | B + R | 0.5M + W |
| Yellow | 0.75Y + 0.5W | R + G | 0.5Y + W |
| White | 2W | W | 2W |

FIG. 5B is a schematic diagram showing a reflective color display 100 according to another embodiment of the present invention. This reflective color display 100 is, for example, an electrophoresis color display, and is similar to the embodiment of FIG. 5A. However, the reflective color display 100 of the embodiment of FIG. 5B further includes an opposite substrate 12. When manufacturing this reflective color display 100, a thin film transistor layer 30, a pixel electrode layer PEL, a color filter layer CF, and a display material layer 20 can be fabricated on the control substrate 10, and then the resulted structure combined with the opposite substrate 12 on which a common electrode layer 14 is fabricated to construct a complete electrophoresis color display 100.

FIG. 5C is a schematic diagram showing a reflective color display 100 according to another embodiment of the present invention. This reflective color display 100 is, for example, an electrophoresis color display, and is similar to the embodiment in FIG. 5B. However, in the embodiment of FIG. 5C, the color filter layer CF of the reflective color display 100 is moved from a position close to the control substrate 10 to a position close to the opposite substrate 12. Namely, the color filter layer CF of the reflective color display 100 is moved to a place between the display material layer 20 and the common electrode layer 14. When manufacturing this reflective color display 100 in FIG. 5C, a thin film transistor layer 30, a pixel electrode layer PEL, and a display material layer 20 are fabricated on the control substrate 10, and then combined with the opposite substrate 12 on which a common electrode layer 14 and a color filter layer CF are fabricated to construct a complete electrophoresis color display 100.

FIG. 5D is a schematic diagram of a reflective color display 100 according to another embodiment of the present invention. This reflective color display 100 is, for example, an electrophoresis color display, and is similar to the embodiment in FIG. 5C. But in in embodiment of FIG. 5D, the color filter layer CF is moved to a position further away from the control substrate 10, that is, on the side of the opposite substrate away from the control substrate 10. The color filter layer CF is arranged on a filter substrate 19 and is located between the opposite substrate 12 and the filter substrate 19. When manufacturing this reflective color display 100, a thin film transistor layer 30, a pixel electrode layer PEL, and a display material layer 20 are fabricated on the control substrate 10. Afterward, the resulting structure is combined with the opposite substrate 12 on which a common electrode layer 14 is fabricated, and then a filter substrate 19 on which a color filter layer CF is fabricated can be bonded to the resulting structure to construct a complete electrophoresis color display 100.

In the reflective color display 100 shown in FIGS. 5B to 5D, similarly, this electrophoresis display material layer 20 includes a micro-partition structure 50 having a plurality of partition walls 52, and a colloidal solution 24 containing a plurality of suspended charged color particles 26 in a cavity 54 defined by each micro-compartment structure 50. The cavity 54 defined by the micro-compartment structure 50 is served as a container for electronic ink (or electrophoresis material). The detail description thereof will be made hereinafter.

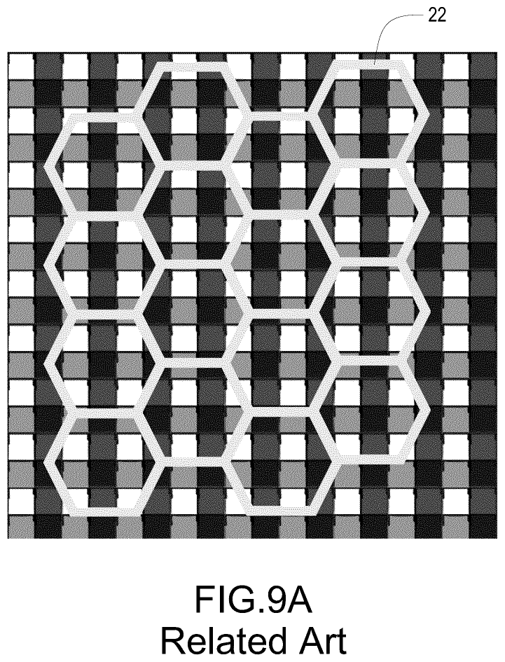

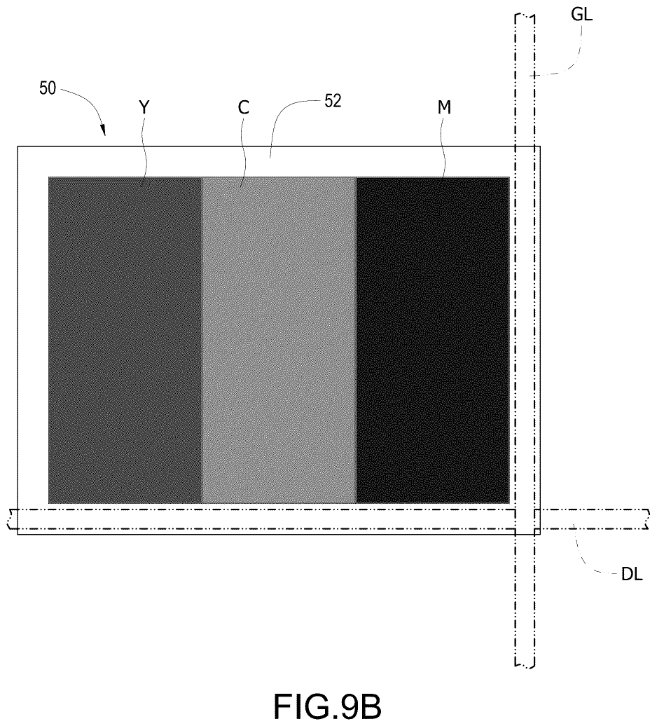

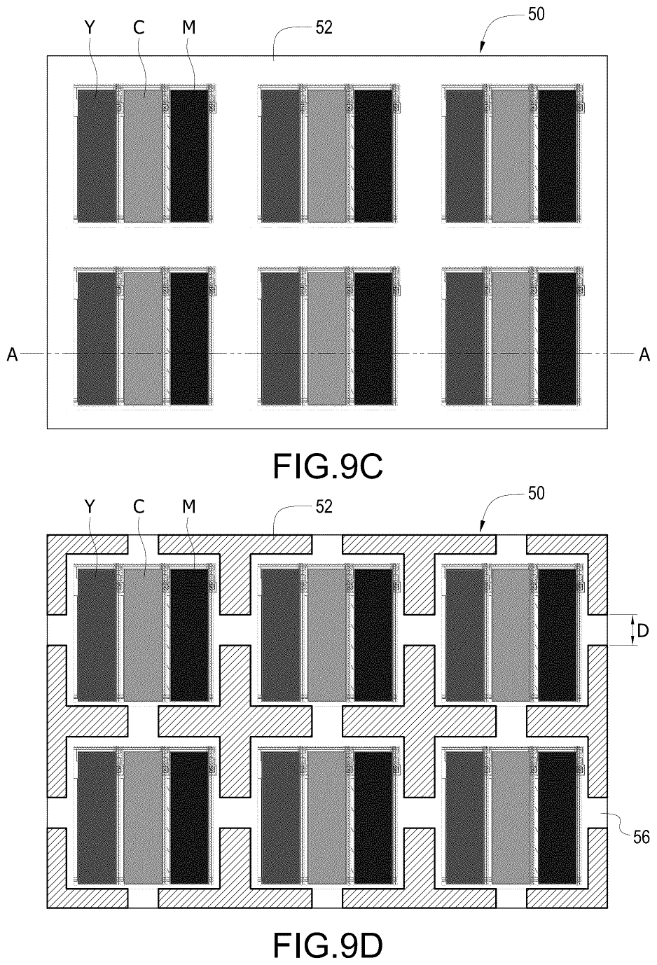

Please refer to FIGS. 9A-9D, those figures show comparison between f the micro-cup compartments of a prior art electrophoresis display and the micro-partition structure of the present invention.

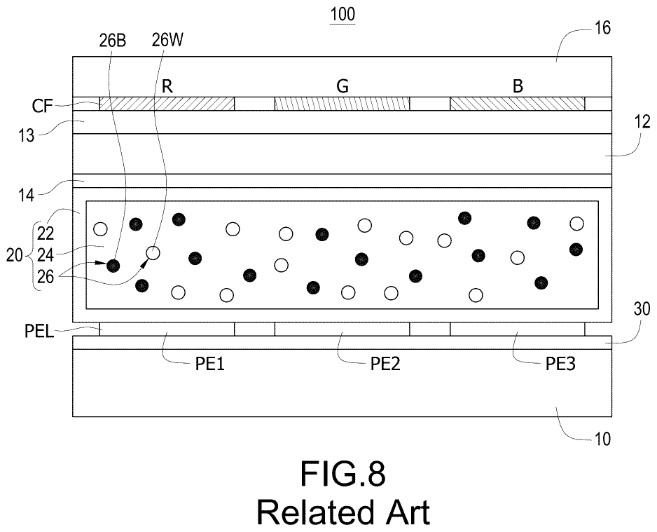

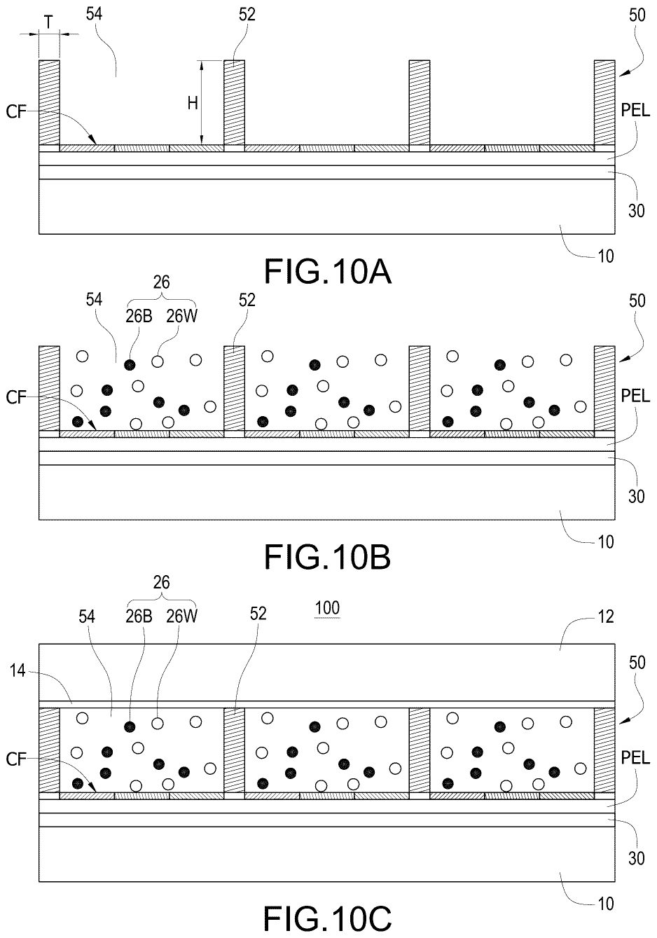

Refer first to FIG. 9A, this figure shows is a top-view of the micro-cup compartment of the prior art electrophoresis display and the color filter layer thereof. The compartment wall thickness (refer to FIG. 10A, the partition wall thickness of the present invention is marked as T, while the compartment wall thickness of the micro-cup 22 in FIG. 9A is also the thickness extending along the parallel direction of the drawing) of the micro-cup 22 in prior art needs to be more than 10 μm to have sufficient support. Moreover, the micro-cup 22 of the prior art electrophoresis display is viewed from an upper projection angle and mostly adopts a hexagonal compartment structure to increase the structural strength, the charged color particle may not arrive within the certain region of the micro-cup compartment wall. The above may be regarded as the key factors affecting the aperture ratio of the display, there is no charged color particle 26 in the certain region in the micro-cup of the prior art electrophoresis display. When the compartment of the micro-cup shown in FIG. 9A is bonded to the control substrate (for example, the control substrate 10 as shown in FIG. 8), the electrodes on the control substrate are covered, causing the display color to be partially obscured, forming background textures that affect imaging quality, and causing color distortion due to the uneven shielding position of the micro-cup compartment on the color filter layer.

Refer to FIG. 9B, according to one embodiment of the present disclosure, the micro-partition structure is made on the substrate, which may accurately align the pixel electrode (the pixel electrode PE) so that the partition wall 52 of the micro-partition structure 50 is formed on the non-display region between the pixels. For the plurality of partition walls, as viewed along the projection direction on the viewing surface, the overlapping area of the partition wall and the pixel electrode may be as small as possible, at least less than 50% of the area of the pixel electrode. In other words, according to the design of the present invention, the micro-partition structure 50 and the partition wall 52 may be made into a rectangular structure close to the shape of the pixels and may fit the boundaries of the pixels without affecting the display. According to the present invention, for example, the photomask may be used for developing the pattern of the photoresist film to make the partition walls. The photoresist film may use materials with higher hardness (for example, transparent photoresist made of acrylic). Furthermore, according to other embodiments of the present invention, the partition wall 52 of the micro-partition structure 50 may also be made of polymer materials (for example, the planarization layer material, resin, or acrylic material). Furthermore, as shown in FIG. 9B, the partition wall 52 of the micro-partition structure 50 may be partially aligned with the gate line GL or the data line DL. In more detail, a plurality of partition walls 52 may overlap with part of the data line DL and/or part of the gate line GL when viewed from the vertical projection direction (namely, a direction perpendicular to the viewing surface).

Since the present invention uses hard polymer materials (e.g. transparent photoresist material) as the partition wall 52 of the micro-partition structure 50, the polymer materials hardness may reach pencil hardness equal to or more than 3H, much higher than the resin material used in the container of the prior art micro-cup (hardness less than 1H). Therefore, the present invention may use the micro-partition structure with thinner wall thickness to support the weight and pressure of the upper and lower substrates, and the wall thickness T (refer to FIG. 10A) of the micro-partition may be less than 10 μm. Refer to FIG. 9C, since the partition wall 52 of the micro-partition structure 50 of the present invention may be accurately positioned on the non-display region of the pixel (the regions between pixels), it will not affect the display quality. Its high-precision characteristics may bring a good yield and reduce production costs. The greater advantage is that the expense and cost of using the prior art micro-cup to make electronic paper is eliminated, the cost of the optical adhesives and the loss of yield caused during bonding is saved by skipping the bonding of the substrate, and a thinner electrophoresis display may be made. In addition, the micro-partition structure 50 may also be made by using the planarization layer (PLN) material and using etching to peel off the area other than the wall surface to complete the micro-partition structure. A thinner electrophoresis display may be made, and the electrophoresis layer 20 with less than 25 μm thickness may be easily made by the micro-partition structure 50 made through the present invention. Namely, the micro-partition wall height H1 (refer to FIG. 10A) may be less than 25 μm. When the thickness of the electrophoresis layer of the electrophoresis display made by the micro-partition structure 50 of the present disclosure is thinner, the distance between the control electrode and the common electrode may be closer, the electric field magnitude may be greater, so that the electrophoresis layer may work at a lower driving voltage, the charged color particle may also move faster and the distance it needs to move is shorter to greatly improve the refresh speed of the screen. As a result, the refresh speed problem that plagues the electrophoresis display may be solved. This problem is especially essential in colored electrophoresis displays.

Refer to FIG. 9D, which is a top-view of the micro-partition structure in accordance with another embodiment of the present invention. According to this embodiment, the partition wall 52 (represented with a slashed figure to highlight its shape) of the micro-partition structure 50 adopts materials with higher hardness. If the partition wall 52 is applied to a bendable flexible electrophoresis display, the substrate used to make the micro-partition structure is a flexible substrate, the substrate may easily break and be damaged due to bending. In order to solve this problem, the micro-partition structure 50 and the partition wall 52 may be made into discontinuous shapes. Refer to the cross-shaped partition wall 52 in FIG. 9D. The slit 56 on the partition wall 52 may be used as a stretch and compress space when the substrate is bent causing the partition wall 52 to be squeezed. According to an embodiment of the present invention, the area of the slit 56 is not more than 50% of the area of the partition wall 52, or the length D of the slit 56 is not more than 50% of the length of the partition wall 52. According to an embodiment of the present invention, the length D of the slit 56 may be more than 0.5 μm to provide a stretch and compress space for the partition wall 52 when it is squeezed. According to an embodiment of the present invention, the cavity formed by the cross-shaped partition walls 52 may accommodate one pixel, for example, one pixel including color filter blocks (CFR, CFG, CFB) with different colors. In addition, although the partition wall 52 shown in FIG. 9D is cross-shaped from a top view to provide the cavity when the adjacent partition walls 52 have the slit, the partition wall 52 of the present invention may also be in other shapes from a top view, such as a T-shape or a U-shape, as long as there is a slit 56 between at least part of the adjacent partition walls 52. In addition, although in the embodiment shown in FIG. 9D, the slit 56 on the partition wall 52 is evenly distributed, it should be noted that in actual production, the slit 56 may have different lengths due to manufacturing process errors. In addition, the slit 56 needs not be communicated to the partition wall 52 along the thickness direction, as long as it may provide a stretch and compress space for the partition wall 52 when the partition wall 52 is squeezed.

FIGS. 10A to 10C are sectional views for showing the flowchart for fabricating a micro partitioned structure according to an embodiment of the present invention. These figures can be used to fabricate, for example, a reflective color display 100 with a micro-partitioned color filter layer as shown in FIG. 5B.

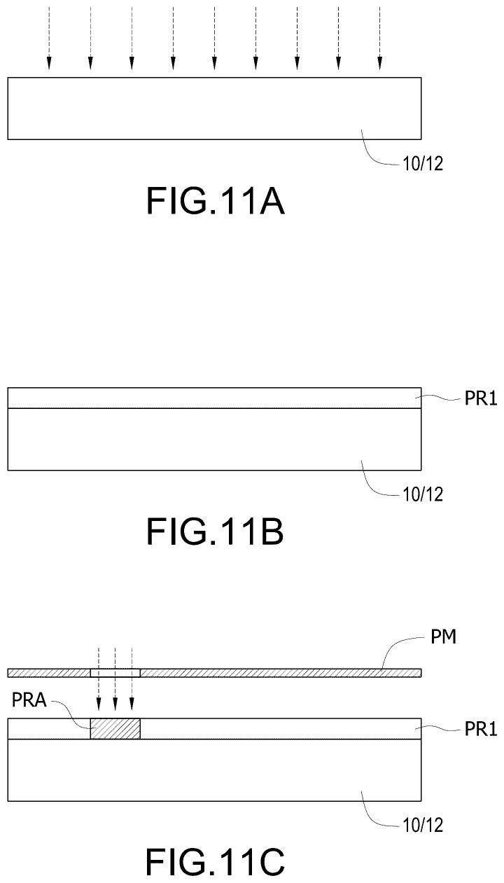

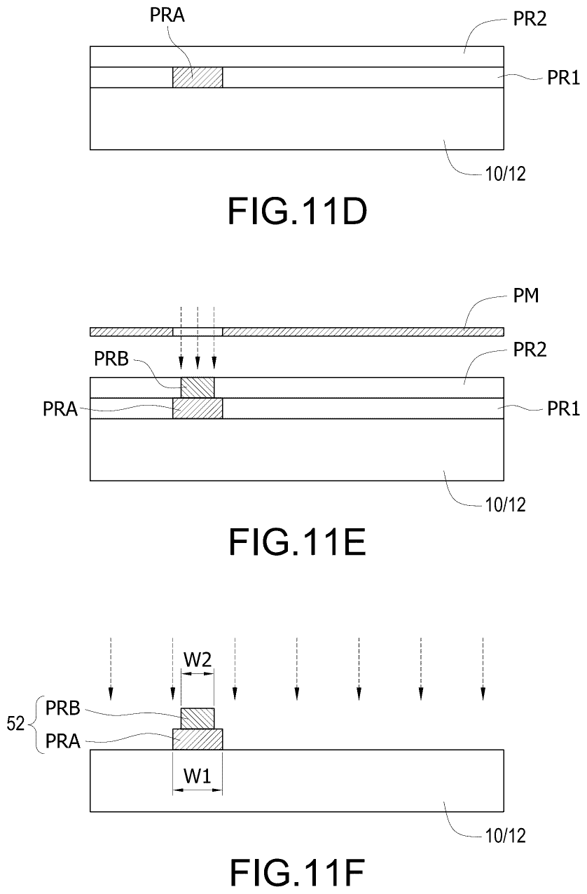

These sectional views respectively show cross-section along line A-A of the structure of FIG. 9C in different manufacturing processes. In this embodiment, the micro-partition structure 50 is made on the color filter layer CF (i.e. on the control substrate 10 side). Refer to FIG. 10A, first, the thin-film transistor layer 30, the transparent pixel layer PEL, and color filter layer CF are formed on the control substrate 10. Then, applying transparent photoresist and conducting exposure/development processes to fabricate the micro-partition structure 50 and the partition wall 52. Since, during the development process, the developable depth is affected by the intensity of light and the number of irradiations, which has a causal relationship; in practice, the thickness of the developable photoresist is usually less than 5 μm due to production cost and yield considerations. When the thickness of the electrophoresis layer is excessive thin, the number of the accommodated color particles is limited, which may affect the number of layers of color particles stacked. When the number of layers of color particles stacked is insufficient, the reflectivity may be affected, causing insufficient reflected light and a decrease in visible brightness. Therefore, the thickness of the electrophoresis layer usually should be not less than 5 μm (the height H1 (refer to FIG. 10A) of the partition wall may be not less than 5 μm). According to one embodiment of the present invention, the thickness of the micro-partition structure 50 (i.e., the height H of the partition wall) is greater than 5 μm (micrometers) and less than 25 μm, and the thickness T of the partition wall is less than or equal to 10 μm. Furthermore, with reference to FIG. 11F, the average cross-sectional width of the partition wall 52 of the micro-partition structure 50 is not greater than 10 μm.

With reference to FIG. 10B, after the partition walls 52 are fabricated, a colloidal solution is filled into the cavities 54 defined by the partition walls 52. The colloidal solution contains charged black particles 26B and/or charged white particles 26W. Afterward, as shown in FIG. 10C, the process performs the manufacturing process of bonding the opposite substrate, that is, the process provides the opposite substrate 12 with a conductive film (e.g. the common electrode layer 14) or the opposite substrate 12 (when the viewing surface is not on the opposite substrate 12 side) without the common electrode layer 14, and uses the optical adhesives between the opposite substrate 12 and the partition wall 52 or applies frame glue on the four borders of the display area and then bonds the opposite substrate 12 with the micro-partition structure 50. Afterward, the process puts the two substrates 10/12 into the gas pressure chamber to heated and pressurize the two substrates. Then, the process squeezes the colloidal solution into and fills the gaps within the micro-partition structure 50. Finally, the process solidifies the optical adhesives or frame glue to complete the finished product of the electrophoresis display 100. As shown in FIG. 10C, the overlapping area of the partition wall 52 with any pixel electrode PE is less than 50% of the area of the pixel electrode (the electrodes in the pixel electrode layer PEL).

Refer to FIG. 11A to FIG. 11F, which illustrates the step of the manufacturing process of fabricating the partition wall 52 on the substrate side (namely, the control substrate 10 side or the opposite substrate 12 side) in accordance with the embodiment of the present invention. According to the present invention, the partition wall 52 may be made directly on one surface of the substrate by applying a transparent photoresist and then performing exposure/development process. In addition, other structures may also be possibly present on the surface of the substrate 10/12 before forming the partition wall 52, such as the pixel electrode layer PEL, the insulation layer, the protective layer, the thin-film transistor layer 30, the color filter layer CF, or the common electrode layer 14. Furthermore, the partition wall 52 is made directly on these structures by applying transparent photoresist and performing exposure/development process. Furthermore, the planarization layer PLN may also be added to other structures (for example, the pixel electrode layer PEL, the thin-film transistor layer 30, and the color filter layer CF) on the substrate, and then the partition wall 52 may be made by applying transparent photoresist and performing exposure/development process. Therefore, although FIG. 11A to FIG. 11F schematically shows that the initial structure is the substrate 10/12, the present invention does not rule out the possible additional structure on the substrate 10/12. As shown in FIG. 11A, first, the process cleans a substrate 10/12. The substrate may be the control substrate 10 or the opposite substrate 12, and there may be other structures on the surface to be cleaned. Then, refer to FIG. 11B, the process coats a first layer photoresist PR1, such as a transparent photoresist material, on the substrate 10/12. Then, refer to FIG. 11C, the process exposes the location where the partition wall 52 is to be formed with a photomask PM to define the first residual photoresist PRA (namely, the first polymer material stack). According to an embodiment of the present invention, the first layer photoresist PR1 is a negative photoresist material, that is, the illuminated part may remain after development. According to another embodiment of the present invention, the first layer photoresist PR1 is a positive photoresist material, and the photomask PM needs to be designed accordingly. Then, referring to FIG. 11D, the process coats a second layer photoresist PR2, such as a transparent photoresist material, on the resulting structure over the substrate 10/12. Then, referring to FIG. 11E, the process performs exposing, that is repeating exposing, the location where the partition wall 52 is to be formed with a photomask PM again to define the second residual photoresist PRB (namely, the second polymer material stack). The residual range of the second layer photoresist may be less than the residual range of the photoresist of the previous layer, to form an upward-decreasing shape. Finally, referring to FIG. 11F, the process develops the resulting structure to form the first residual photoresist PRA and the second residual photoresist PRB. The resulting structure (the first polymer material stack stacked on the second polymer material stack) by stacking is the partition wall 52 of the present invention. Through the above manufacturing process, by a repeated coating of photoresist, exposing, and final developing, the developer removes the unnecessary parts (hollowed areas), leaving a sufficiently high micro-partition wall. The process may either repeat more than one photoresist coating, exposing and developing, or repeat more than two photoresist coating, exposing, and two developing. The area of each exposure may be reduced to allow the partition wall to be thinner, and the diameter of the partition wall may be reduced by a step difference (W1-W2) less than 5 μm for each layer. Refer to FIG. 11B, after fabricating the partition wall 52, under vacuum environmental conditions, the process fills in the colloidal solution in the cavities 54 defined by the partition walls 52 and this may avoid filling failure caused by air remaining in the micro-partition structure. The filling-in method may first use a mask plate (not shown in figures) to cover the non-display region, and then spray the heated colloidal solution into the display region by spray equipment. Since there may be alignment errors in each layer of exposure, in order to improve the yield of subsequent filling of the colloidal solution, according to an embodiment of the present invention, the design may adopt the design in which the wall thickness decreases as the stack grows. As a result, the problem that the wall surface becomes uneven and the contact area becomes smaller when filling the colloidal solution may be avoided. Furthermore, the problem of forming unfilled gaps when filling in the colloidal solution and causing more defective products, may be avoided. In practice, the exposed line width of the coated photoresist (namely, the first polymer material stack) of the first layer may be the largest and then the exposed line widths decrease with each layer. For example, the width (the width of the section) decrement between two adjacent layers of polymer material stacks in the partition wall is less than 5 μm. The shape of the wall of the micro-partition structure is made to be thicker at the bottom and thinner at the top (namely tapered shape with a width-decreasing top). As shown in FIG. 11F, the width difference (amount of decrement) between the width W2 of the second polymer material stack and the width W1 of the first polymer material stack is less than 5 μm.

In the embodiment, the manufacturing process of the partition wall 52 of FIG. 17A to FIG. 17F may be performed after the pixel electrode layer PEL is made, or the manufacturing process of the partition wall 52 of FIG. 11A to FIG. 11F may be performed after the planarization layer PLN is made on the pixel electrode layer PEL. The material of the above planarization layer PLN may be organic insulating material, inorganic insulating material, or a combination thereof. According to one embodiment, the organic insulating material may be polyimide (PI), polyamic acid (PAA), polyamide (PA), polyvinyl alcohol (PVA), polyvinyl cinnamate (PVCi), poly methyl methacrylate, or other suitable photoresist materials or combinations thereof. In addition, the inorganic insulating material may be silicon oxide, silicon nitride, silicon oxynitride, siloxane, or a combination thereof.

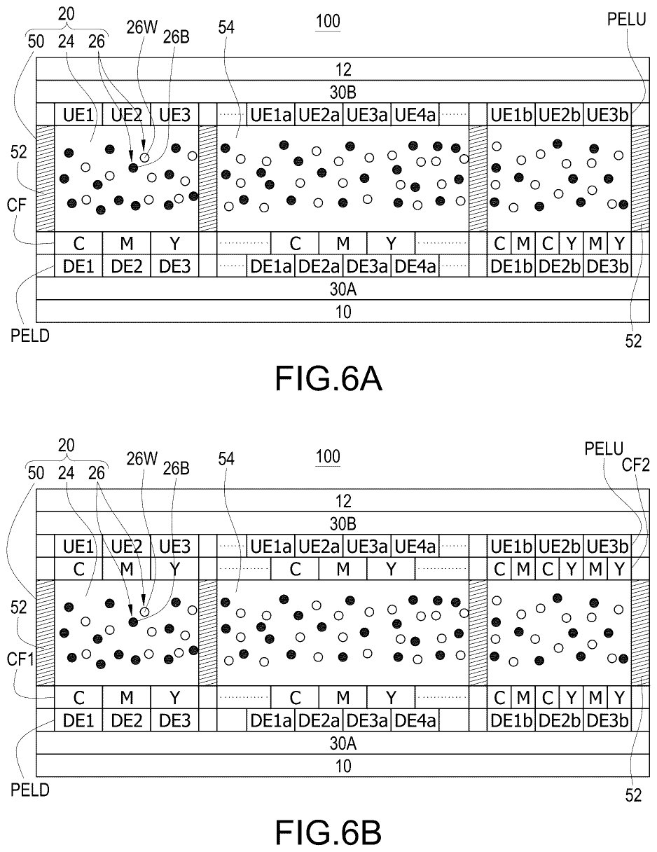

FIG. 6A is a schematic diagram of a reflective color display 100 according to another embodiment of the present invention. This reflective color display 100 is, for example, an electrophoresis color display, and has double-sided display (one side is black and white, while the other side is color). This reflective color display 100 includes, from top to bottom, an opposite substrate (second substrate) 12, an opposite thin-film transistor layer (second thin-film transistor layer) 30B, an opposite pixel electrode layer (second pixel electrode layer) PELU, a display material layer 20 (for example, an electrophoresis layer), a color filter layer CF, a pixel electrode layer (first pixel electrode layer) PELD, a thin-film transistor layer (first thin-film transistor layer) 30A, and a control substrate (first substrate) 10. As shown in the figure, the opposite thin-film transistor layer (second thin-film transistor layer) 30B and the opposite pixel electrode layer (second pixel electrode layer) PELU are arranged on one surface of the opposite substrate (second substrate) 12. The opposite thin-film transistor layer (second thin-film transistor layer) 30B includes multiple thin-film transistors, multiple gate lines, and multiple data lines (the details thereof will be described later). The opposite pixel electrode layer (second pixel electrode layer) PELU includes multiple pixel electrodes UE1, UE2, UE3, UE1a, UE2a, UE3a, UE4a, UE1b, UE2b, and UE3b. The thin-film transistor layer (first thin-film transistor layer) 30A and the pixel electrode layer (first pixel electrode layer) PELD are arranged on one surface of the control substrate (first substrate) 10. The thin-film transistor layer (first thin-film transistor layer) 30A includes multiple thin-film transistors, multiple gate lines and multiple data lines (the details thereof will be described later), and the pixel electrode layer (first pixel electrode layer) PELD includes multiple pixel electrodes DE1, DE2, DE3, DEla, DE2a, DE3a, DE4a, DE1b, DE2b, DE3b.

FIG. 6B is a schematic diagram of a reflective color display 100 according to another embodiment of the present invention. This reflective color display 100 is, for example, an electrophoresis color display, and specifically an electrophoresis color display capable of double-sided display (both sides are color). The structure of this reflective color display 100 is generally similar to the embodiment in FIG. 6A, but an additional color filter layer (second color filter layer) CF2 is provided between the display material layer 20 and the opposite pixel electrode layer (second pixel electrode layer) PELU to achieve a double-sided color display. In this case, the original color filter layer CF is replaced by the first color filter layer CF1.

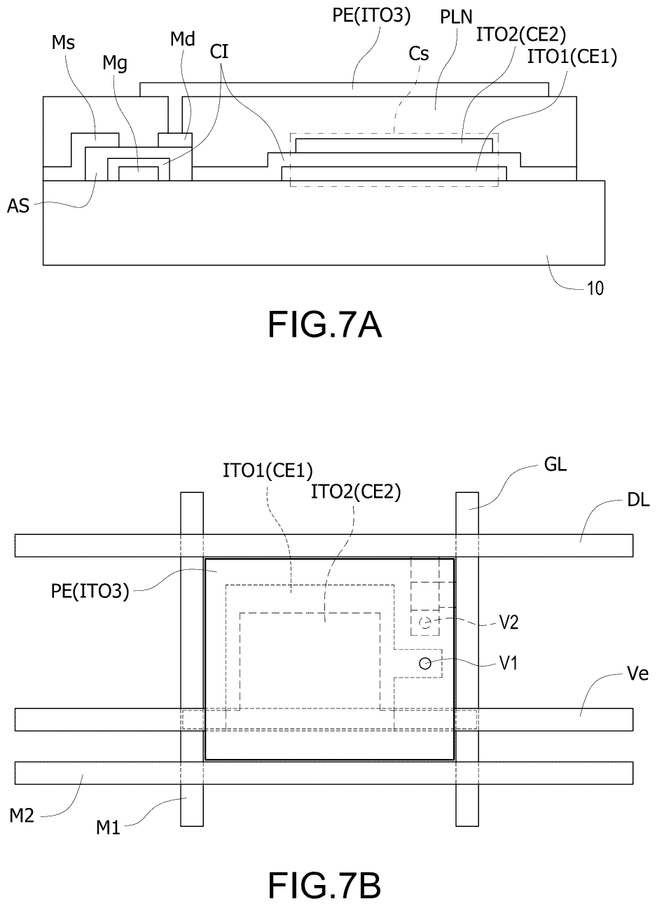

For the reflective color displays 100 in the above embodiments, please refer to FIGS. 7A and 7B, the structure and manufacturing process of the thin film transistor layer 30 and related components on the control substrate 10 of the present invention are explained.

According to the present invention, when fabricating an electrophoresis display 100 (for example, the electrophoresis display shown in FIG. 5B), for the control substrate 10 side, a metal thin film is first formed on the upper surface of the control substrate 10 using a deposition process or a sputtering process and then a first metal layer Mlis formed using a lithography process. This first metal layer M1 is used to form the gate metal Mg and the gate line GL. Afterward, a transparent conductive material thin film is formed using a sputtering process, and a first transparent conductive layer ITO1 is formed using a lithography process. The above two steps can also be interchanged, that is, the first transparent conductive layer ITO1 is formed first, and then the first metal layer M1 is formed. Afterward, a capacitor insulating layer CI (for example, using the material of SiNx or SiO2) for the storage capacitor Cs and an a-Si layer AS are deposited, and the semiconductor portion of the thin-film transistor in the thin-film transistor layer 30 is defined using a photolithography process. Afterward, a metal thin film is fabricated on the resulting structure using a deposition or sputtering process, and a second metal layer M2 is fabricated using a photolithography process. This second metal layer M2 is used to form the source metal Ms, the drain metal Md, and the data line DL. Afterward, a transparent conductive material thin film is fabricated using a sputtering process, and a second transparent conductive layer ITO2, which is served as the second storage capacitor CE2, is fabricated using a photolithography process. The two steps described above can also be interchanged. Namely, the second transparent conductive layer ITO2 is formed first, and the second metal layer M2 is then formed. Then, a planarization layer PLN is fabricated on the resulting structure using a coating and lithography process. Afterward, a transparent conductive material film is fabricated using a sputtering process, and the pixel electrode PE (for example, the third transparent conductive layer ITO3) of the pixel electrode layer PEL is fabricated using a lithography process. A display material layer 20 containing a hollow cavity 22 is then laminated or fabricated on the pixel electrode layer PEL. For example, a resin film is formed on a polymer substrate, and indentations are pressed into the resin film using a roller to create a hollow micro-cup structure 22 and then the resin film is cured. The hollow micro-cup 22 structure serves as a container for electronic ink. A colloidal solution 24 containing charged color particles 26 is then filled into the hollow micro-cup 22 structure, and the hollow micro-cup 22 is subsequently sealed and hardened with adhesive to form a sealed cavity, which becomes the display material layer 20 (for example, the electrophoresis layer). For detailed fabrication process, please refer to Taiwan Patent Application No. 93100767. Afterward, the opposite substrate 12 is fabricated. A common electrode layer 14 is formed on the opposite substrate 12, or the common electrode layer 14 can be omitted or formed on other location. Finally, the side of the control substrate 10 with the display material layer 20 is bonded to the opposite substrate 12 with optical adhesive.

With reference to FIG. 7B, the topmost pixel electrode PE is made of a transparent conductive material, such as indium tin oxide (ITO) or a similar transparent conductive material, and is electrically connected to the first transparent conductive layer ITO1 (first storage electrode CE1) of the storage capacitor Cs through the via V1; furthermore, the pixel electrode PE is also electrically connected to the drain metal Md through the via V2. Furthermore, although not fully illustrated in FIGS. 7A and 7B, in each embodiment of the present invention, the thin-film transistor layer 30 (including thin-film transistor layers 30A and 30B) comprises a plurality of thin-film transistors, a plurality of gate lines GL, and a plurality of data lines DL. The plurality of gate lines GL are arranged along a first direction, and the plurality of data lines DL are arranged along a second direction, the first direction and the second direction are substantially perpendicular to each other. The pixel electrode layer PEL comprises a plurality of pixel electrodes PE.

Furthermore, in the above embodiments, each of the plurality of color filter blocks is a non-primary color light filter block, such as cyan (C), magenta (M), and yellow (Y) filter blocks. According to one embodiment of the present invention, one, or two or all of the color filter blocks has a full width at half maximum (FWHM) of more than 150 nm in the permissible spectrum within the visible light range of 380 nm to 780 nm.

It shall be understood that the present invention may have other types of embodiments, and a person with ordinary skills in the art of the technical field of the present invention may make various changes and modifications corresponding to the present invention without deviating the principle and substance of the present invention; however, such corresponding changes and modification shall be considered to be within the claimed scope of the present invention.

What is claimed is:

1. A reflective color display with micro-partitioned color filter layer, the reflective color display comprising:
a first substrate comprising a first surface and a second surface, wherein a thin-film transistor layer and a pixel electrode layer are formed on the second surface, the thin-film transistor layer comprises a plurality of thin-film transistors, a plurality of gate lines and a plurality of data lines and a plurality of storage capacitors, the plurality of gate lines are arranged along a first direction, the plurality of data lines are arranged along a second direction, the first direction and the second direction are substantially perpendicular to each other, and the pixel electrode layer comprises a plurality of pixel electrodes;
a color filter layer comprising a plurality of color filter blocks, wherein for at least half of the color filter blocks, any two adjacent color filter blocks do not overlap in the projection direction, or an overlapping area of the adjacent color filter blocks in the projection direction is less than 30% of an area of a single one of the filter color blocks; wherein part of the color filter blocks have one-to-one correspondence with the plurality of pixel electrodes, part of the color filter blocks have multiple-to-one or one-to-multiple correspondence with the plurality of pixel electrodes; and
a display material layer arranged in a direction away from the second surface of the first substrate, wherein the display material layer comprises micro-partition structures having multiple partition walls, and a colloidal solution containing multiple suspended charged color particles filled in cavities defined by each of the micro-partition structures.

2. The reflective color display with micro-partitioned color filter layer in claim 1, wherein the color filter layer is arranged between the first substrate and the display material layer.

3. The reflective color display with micro-partitioned color filter layer in claim 2, wherein the pixel electrode is made of transparent conductive material.

4. The reflective color display with micro-partitioned color filter layer in claim 1, wherein the display material layer is filled with a colloidal solution containing charged color particles of at least one color.

5. The reflective color display with micro-partitioned color filter layer in claim 1, wherein a height of the partition wall is less than 25 μm.

6. The reflective color display with micro-partitioned color filter layer in claim 1, wherein an overlap area between the partition wall and any of the pixel electrodes is less than 50% of an area of the pixel electrode.

7. The reflective color display with micro-partitioned color filter layer in claim 1, further comprising a second substrate, wherein the display material layer is sandwiched between the first substrate and the second substrate, a second thin-film transistor layer and a second pixel electrode layer are arranged on a third surface of the second substrate, the second thin-film transistor layer comprises a plurality of thin-film transistors, a plurality of gate lines and a plurality of data lines, and the second pixel electrode layer comprises a plurality of pixel electrodes.

8. The reflective color display with micro-partitioned color filter layer in claim 7, further comprising a second color filter layer containing a plurality of color filter blocks, wherein part of the filter color blocks in the second color filter layer are in one-to-one correspondence with the plurality of pixel electrodes of the second pixel electrode layer, and part of the color filter blocks in the second color filter layer are in multiple-to-one or one-to-multiple correspondence with the plurality of pixel electrodes of the second pixel electrode layer.

9. The reflective color display with micro-partitioned color filter layer in claim 7, wherein the color filter layer is arranged between the second substrate and the display material layer.

10. The reflective color display with micro-partitioned color filter layer in claim 9, further comprising a common electrode layer arranged between the second substrate and the display material layer.

11. The reflective color display with micro-partitioned color filter layer in claim 1, wherein at least six filter blocks are combined into a full-color color filter pixel unit.

12. The reflective color display with micro-partitioned color filter layer in claim 1, wherein the plurality of color filter blocks are non-primary color filter blocks.

13. The reflective color display with micro-partitioned color filter layer in claim 12, wherein one of the color filter blocks has a full width at half maximum (FWHM) of more than 150 nm in a permissible spectrum within a visible light range of 380 nm to 780 nm.

14. The reflective color display with micro-partitioned color filter layer in claim 11, wherein each full-color filter pixel unit comprises a magenta filter block, a yellow filter block, and a cyan filter block having one-to-one correspondence with the pixel electrode, and comprises another magenta filter block, another yellow filter block, and another cyan filter block having one-to-two correspondence with the pixel electrode.

15. The reflective color display with micro-partitioned color filter layer in claim 11, wherein each full-color filter pixel unit comprises a magenta filter block, a yellow filter block, and a cyan filter block having one-to-one correspondence with the pixel electrode, and comprises another magenta filter block, another yellow filter block, and another cyan filter block having two-to-one correspondence with the pixel electrode.

16. The reflective color display with micro-partitioned color filter layer in claim 1, wherein when the color display displays white color, a display brightness thereof is not less than 50% of a brightness of a full white screen.

17. The reflective color display with micro-partitioned color filter layer in claim 11, wherein the full-color filter pixel units are arranged in a horizontal direction and a vertical direction to form a complete color filter layer.

18. The reflective color display with micro-partitioned color filter layer in claim 11, wherein the full-color filter pixel units are arranged in a horizontal direction or a vertical direction and there is a differential displacement between adjacent rows or columns in the vertical direction or the horizontal direction.

19. The reflective color display with micro-partitioned color filter layer in claim 18, wherein the differential displacement is greater than or equal to one differential unit.

20. The reflective color display with micro-partitioned color filter layer in claim 19, wherein the differential unit is area of one pixel electrode.

21. The reflective color display with micro-partitioned color filter layer in claim 19, wherein the differential unit is half area of one pixel electrode.
